(19) United States
(12) Patent Application Publication
(10) Pub. No.: US 2005/0038582 A1
(43) Pub. Date: Feb. 17, 2005

(54) Method and device for implementing measures for averting danger for living beings in motor vehicles

(76) Inventors: Michael Arndt, Reutlingen (DE); Gerd Lorenz, Reutlingen (DE); Daniela Winkler, Munchen (DE)

Correspondence Address: KENYON & KENYON, ONE BROADWAY, NEW YORK, NY, 10004, US

(21) Appl. No.: 10/894,673

(22) Filed: Jul. 19, 2004

(30) Foreign Application Priority Data
Jul. 17, 2003 (DE) 103 32 516.6

(51) Int. Cl. G06F 19/00

(52) U.S. Cl. 701/29; 340/438

(57) ABSTRACT

A method for implementing measures to avert danger for living beings in a compartment in a motor vehicle, in which a carbon dioxide variable describing the carbon dioxide content or the rate of increase of the carbon dioxide content of the air in this space is detected; and in which a temperature variable representing the room temperature in this space is determined. The temperature variable is compared to a temperature-threshold value, and in the event that the temperature variable exceeds a temperature threshold value, the danger-averting measures in response to the temperature threshold value being exceeded are implemented only if the carbon dioxide variable has exceeded a carbon dioxide threshold value.

### FIELD OF THE INVENTION

The present invention is based on a method and a device for maintaining an air state in the passenger compartment of motor vehicles that poses no health risk.

### BACKGROUND INFORMATION

German Published Patent Application No. 101 01 656 describes a device for occupant classification in a motor vehicle which is used to classify occupants with the aid of a CO₂ sensor. Both the CO₂ content and the time characteristic of the signals are used to classify vehicle occupants. The CO₂ sensors are advantageously situated in front of the individual persons so that a simple measurement is possible. In combination with another different sensor, the CO₂ sensor may also be used for occupant classification and here in particular for a plausibility check. A processor, which analyzes the signals from CO₂ sensors, polls the CO₂ sensor cyclically. For the plausibility check, the processor may also consider the signals of all CO₂ sensors installed in the passenger compartment.

German Published Patent Application No. 196 07 637 describes a method and a device for maintaining an air state in the passenger compartment of motor vehicles that poses no health risk is known. To ensure that no hazardous states of the breathing air occur in a motor vehicle whose ventilation device is shut off, it is proposed to automatically implement a supply of fresh air to the passenger compartment when such air states occur. Such air states or their possibility are able to be detected by sensors and be converted in a control device into actuating signals for an actuating element that automatically switches on the ventilation device.

### SUMMARY OF THE INVENTION

The present invention relates to a method for implementing measures to avert danger for living beings in a compartment in a motor vehicle in which
the room temperature in this space is ascertained, or a temperature variable representing the room temperature; and
a carbon dioxide-variable describing the carbon dioxide content is detected or the rate of increase in the carbon dioxide content in the air in this space.

According to the present invention:
the temperature or the temperature variable is compared with a temperature threshold value; and
in the event that the temperature or the temperature variable exceeds a temperature threshold value, the danger-averting measures in response to the temperature threshold value being exceeded are implemented only if the carbon dioxide variable has exceeded a carbon dioxide threshold value.

This prevents unnecessary activations of the danger-averting measures at low temperatures. At high temperatures, in particular, danger-averting measures are taken only if passengers are detected in the vehicle.

An advantageous embodiment of the present invention is characterized in that the carbon dioxide variable is ascertained only when the temperature is higher than a temperature threshold value. This prevents unnecessary activations of the carbon dioxide sensor. The carbon dioxide sensor uses substantially more energy in its operation than a temperature sensor.

An advantageous refinement of the present invention is characterized in that
the carbon dioxide content of the air is determined by a carbon dioxide sensor; and
the rate of increase in the carbon dioxide content of the air is determined as a function thereof, as carbon dioxide variable.

This allows the rate of increase in the carbon dioxide concentration to be determined easily, for example by forming a difference quotient.

An advantageous refinement of the present invention is characterized in that as danger-averting measures
a warning signal is indicated and/or forced ventilation measures are taken for the space in the vehicle and/or measures are taken to lower the carbon dioxide concentration in the space in the motor vehicles and/or measures are taken to lower the room temperature and/or measures are taken to unlock the door.

An advantageous embodiment of the present invention is characterized in that the danger-averting measures are implemented only when the engine of the motor vehicle is shut off. In this way, it is possible to prevent that danger-averting measures are triggered when the vehicle is left only briefly (with the engine still running).

The device according to the present invention for activating and implementing danger-averting measures in a space in a motor vehicle includes
a temperature sensor for ascertaining the room temperature in this space and
a carbon dioxide sensor for ascertaining a carbon dioxide variable describing the carbon dioxide content or the rate of increase of the carbon dioxide content of the air in this space.

According to the present invention:
evaluation means are provided by which the temperature is compared with a temperature threshold value; and
danger-averting means by which, when the temperature exceeds a temperature-threshold value, the danger-averting measures in response to an exceeding of the temperature threshold value are implemented only if the carbon dioxide variable has risen beyond a carbon dioxide threshold value.

An advantageous refinement of the present invention is characterized in that the temperature sensor is integrated in the carbon dioxide sensor. This results in a particularly compact design.

One advantageous refinement of the present invention is characterized in that the carbon dioxide sensor is a micromechanical carbon dioxide sensor based on an optical principle.

An advantageous embodiment of the present invention is characterized in that the carbon dioxide sensor is additionally used for leakage monitoring of a carbon dioxide-based air-conditioning system. This constitutes a double benefit.

Of course, the advantageous embodiments of the device according to the present invention also translate into advantageous embodiments of the method according to the present invention, and vice versa.

### BRIEF DESCRIPTION OF THE DRAWINGS

FIG. 1 shows the configuration of the device according to the present invention.

FIG. 2 shows the sequence of the method according to the present invention.

### DETAILED DESCRIPTION

Hereinafter, instead of the notation “CO₂” (the “2” written in subscript), the notation “CO2” will be used with the same meaning.

In the future, CO2 sensors will be utilized for comfort control and/or leakage monitoring of air-conditioning systems in motor vehicles. These sensors are able to detect the CO2 concentration of the air inside a motor vehicle with a resolution of more than 500 ppm (ppm=parts per million). To compensate for the ambient temperature, a temperature sensor is integrated in these sensors as well; the analysis of the sensors is performed via an integrated microprocessor, for example, so that a time signal is made available from its pulse frequency as well. If the information available in the sensor, i.e., temperature, “vehicle locked”, time and carbon dioxide level (and/or its rate of increase) is combined, a warning signal regarding the risk of occupants left behind in a locked vehicle may be derived therefrom, the risk being due to heating caused by intensive sun irradiation, for instance. Additional sensors such as motion detectors will not be necessary.

The rate of increase of the interior temperature of a locked motor vehicle parked in full sunlight amounts to several Kelvin per minute. Depending on the outside temperature, the temperature inside the locked vehicle asymptotically approaches a limit value. This limit value is determined solely by the balance between the absorption of radiant energy (through exposure to sunlight, the greenhouse effect) and the emission of heat energy to the environment as a function of the difference between inside and outside temperature via convection and radiation by the vehicle shell. When the solar irradiation is intense, inside temperatures of >60° C. are reached within an hour even at moderate outside temperatures of up to 25° C. Within a short time, the interior space reaches temperatures that are immediately life-threatening, in particular for small children but also for other mammals left in the vehicle. The temperature sensitivity in all mammals, and also in humans, is approximately proportional to the body weight. The sensor design is therefore configured in such a way that the sensor checks with rising inside temperatures whether a person or other mammal is in the locked vehicle and whether the permissible temperature load is exceeded as a function of its body weight.

Humans and other mammals increase the CO2 content of their respiratory air by approximately 4% due to respiration. Inhaled air (fresh air) has a CO2 concentration of approximately 0.03%, exhaled air from a human, for example, contains more than 4% CO2. The respiratory volume of humans and other mammals is approximately proportional to their body weight. With an inhaled and exhaled volume of approximately 15 ml/kg body weight and a respiratory frequency of between 15 and 30 breaths per minute, a small child, for example, will increase the CO2 level of three liters of respiratory air by 4% CO2 per minute. In a closed passenger vehicle with a net volume of 2000 liters, for example, the CO2 content of the air inside the vehicle will rise by more than 0.3% per hour. With a resolution of at least 0.05% CO2 for automotive CO2 sensors, such a CO2 increase is reliably detected within approximately 10 to 15 minutes even in large vehicles. A CO2 sensor of this type used for comfort control and/or leakage monitoring of the air conditioning system is thus able to reliably detect the presence of a living being left in a locked vehicle. The temperature sensor provided in the sensor for compensation of the ambient temperature is also able to detect the interior temperature of the vehicle. From these two pieces of information it may be derived whether the living being inside the vehicle is endangered by the temperature increase and possibly also by the rising CO2 concentration.

It may be specified that a dangerous situation is at hand when the engine is shut off and the interior temperature increases to more than 60° C. and the CO2 concentration rises to 0.05%, for instance, within 10 minutes.

To rule out a risk to life, a warning signal may be triggered in this case and/or the door lock may be released.

It is also conceivable that below a threshold defined by the manufacturer as the maximally allowed level, the temperature and/or CO2 level(s) may be preselected by the user of the vehicle as individual threshold value(s) (possibly also as a function of time). It is likewise conceivable for a warning to be triggered as a function of the rate of increase in the CO2 concentration at different temperature levels because small children have much lower tolerance of high temperatures (i.e., a slower increase in CO2 concentration) than do older children or adults.

The method according to the present invention compares the temperature ascertained in the vehicle interior with a limit value. If this limit value is reached, the carbon dioxide concentration or its rate of increase in the motor vehicle is processed, evaluated, polled or ascertained. If the presence of a living being inside the motor vehicle is concluded, responses (opening of windows, ventilation, alarm . . . ) are triggered.

A temperature sensor may be operated at much lower power consumption than a carbon dioxide sensor. The typical power consumption of the temperature sensor is in the range of a few micro-watts to maximally a few milli-watts, the typical power consumption of a carbon dioxide sensor lies in the range of approximately 1 to 2 watts. If the temperature sensor whose determined temperature is used as first trigger criteria is in operation permanently or intermittently, the energy supply of the vehicle will be drained only slightly. If the carbon dioxide sensor is put into operation only once the temperature has exceeded a limit value, the overall power consumption is reduced considerably without a negative effect on the desired target protection.

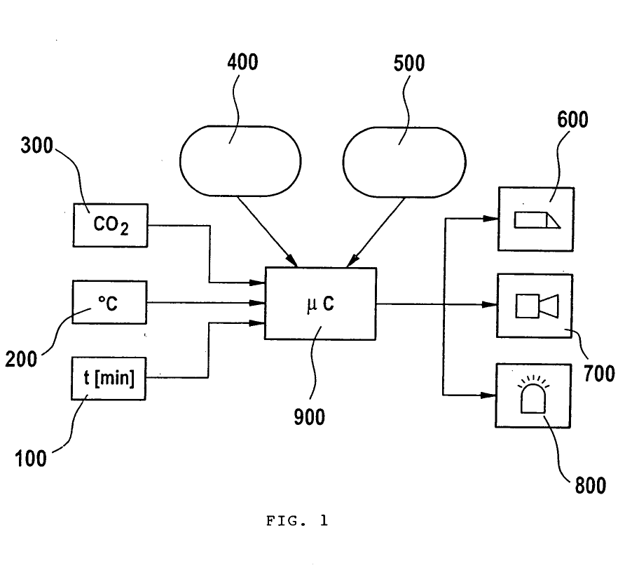

The design of the device according to the present invention is shown in FIG. 1. The meanings in this context are:
100=time acquisition;
200=temperature sensor;
300=gas sensor for detecting the carbon dioxide concentration;
400=status detection of the ignition, i.e., ignition on or off;
500=status detection of the door locks, i.e., doors locked or unlocked;
600=door opener;
700=horn or signal generator;
800=warning light;
900=control device.

Control device 900 receives its input signals from blocks 100, 200, 300, 400 and 500. Horn 700 is activated when a critical state for a vehicle occupant is detected (e.g., ignition off, door locked, high temperature in the interior of the vehicle and the rate of increase of the carbon dioxide concentration in a critical range). In addition or alternatively, the doors may also be unlocked (block 600) and a warning light 800 activated.

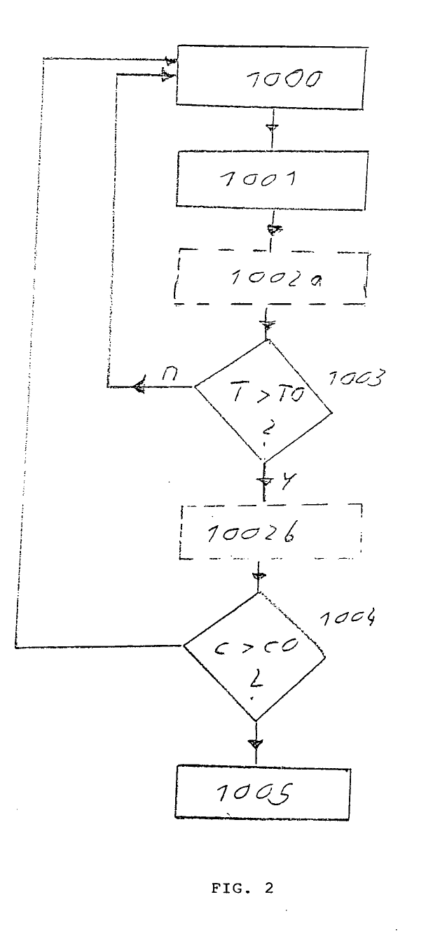

The sequence of a specific design of the method according to the present invention is shown in FIG. 2. In this sequence
the method is started in block 1000;
the room temperature is then determined in block 1001;
subsequently the carbon dioxide variable is optionally ascertained in block 1002a. Block 1002a may also be omitted and the carbon dioxide variable be determined in block 1002b instead;
Subsequently, it is polled in block 1003 whether room temperature T exceeds a limit value TO.

If the answer is “no” (indicated as “n” in FIG. 2), then the system branches back to block 1000. On the other hand, if the answer is “yes” (indicated as “y” in FIG. 2), then the system branches to block 1002b. In block 1002b, the carbon dioxide concentration is optionally ascertained. Block 1002b is omitted if the carbon dioxide concentration has already been determined in block 1002a.

Subsequently, it is queried in block 1004 whether carbon dioxide concentration c exceeds a limit value cO.

If the answer is “no” (indicated as “n” in FIG. 2), then the system branches back to block 1000. On the other hand, if the answer is “yes” (indicated as “y” in FIG. 2), then the system branches to block 1005. In block 1005, danger-averting measures are implemented.

1. A method for implementing a measure to avert danger for living beings in a compartment in a motor vehicle, comprising:
determining a temperature variable representing a room temperature in the compartment;
detecting a carbon dioxide variable describing one of a carbon dioxide content and a rate of increase in the carbon dioxide content of air in the compartment;
comparing the temperature variable to a temperature threshold value; and
if the temperature variable exceeds the temperature threshold value, implementing a danger-averting measure in response to the exceeding of the temperature threshold value only if the carbon dioxide variable has exceeded a carbon dioxide threshold value.

2. The method as recited in claim 1, wherein the carbon dioxide variable is ascertained only if the temperature variable is greater than the temperature threshold value.

3. The method as recited in claim 1, wherein:
the carbon dioxide content of the air is determined by a carbon dioxide sensor; and
the rate of increase in the carbon dioxide content of the air is determined as a function thereof, as the carbon dioxide variable.

4. The method as recited in claim 1, wherein the danger-averting measure includes at least one of:
a warning signal,
a forced ventilation of the compartment,
a lowering of a carbon dioxide concentration in the compartment,
a lowering of the room temperature, and
an unlocking of a door.

5. The method as recited in claim 4, wherein the danger-averting measure is implemented only when an engine of the motor vehicle is shut off.

6. A device for activating and implementing a measure to avert danger for living beings in a space in a motor vehicle, comprising:
a carbon dioxide sensor for ascertaining a carbon dioxide variable describing one of a carbon dioxide content and a rate of increase of the carbon dioxide content of air in the space;
a temperature sensor for ascertaining a temperature variable representing a room temperature in the space;
an evaluation arrangement by which the temperature variable is compared with a temperature threshold value; and
a danger-averting arrangement by which, if the temperature variable exceeds the temperature threshold value, the danger-averting measure in response to the exceeding of the temperature threshold value are implemented only if the carbon dioxide variable has exceeded a carbon dioxide threshold value.

7. The device as recited in claim 6, wherein the temperature sensor is integrated in the carbon dioxide sensor.

8. The device as recited in claim 6, wherein the carbon dioxide sensor includes a micromechanical carbon dioxide sensor based on an optical principle.

9. The device as recited in claim 8, wherein the carbon dioxide sensor is used for leakage monitoring of a carbon dioxide-based air conditioning system.
